(19) United States
(12) Patent Application Publication
(10) Pub. No.: US 2020/0121026 A1
(43) Pub. Date: Apr. 23, 2020

(54) Ventilated Support Device

(71) Applicant: Ji Shen, San Diego, CA (US)

(72) Inventor: Ji Shen, San Diego, CA (US)

(73) Assignee: Ji Shen, San Diego, CA (US)

(21) Appl. No.: 16/163,424

(22) Filed: Oct. 17, 2018

(51) Int. Cl. A43B 17/08; A43B 7/08

(52) U.S. Cl. CPC A43B 17/08; B32B 3/18; A43B 7/081

(57) ABSTRACT

Various embodiments of the present disclosure provide a ventilated support device and method. In some embodiments, the device comprises a first layer having a first side and a second side, a plurality of flexible support capsules disposed on the second side of the first layer, a plurality of ventholes extending from the first side to the second side of the first layer, and a plurality of vias disposed among the plurality of support capsules; wherein the first layer is sufficiently flexible to deform under an externally-applied force; wherein the plurality of support capsules comprises a plurality of flexible materials such that they force air movement through the plurality of vias. Other embodiments comprise a shoe with an integrated ventilated support device, comprising an upper and a sole; wherein the ventilated support device is disposed between the upper and the sole; and the ventilated support device comprises: a first layer, a second layer, a plurality of flexible support capsules disposed between the first layer and the second layer, and a plurality of vias interposed among the plurality of support capsules. Other embodiments comprise a method for ventilation comprising applying a force to a first layer comprising a flexible material, wherein the force is transferred from the first layer to a plurality of flexible support capsules disposed between the first layer and a second layer and deforming at least one of the plurality of flexible support capsules, thereby displacing air through a plurality of vias interspersed among the plurality of support capsules.

### CROSS-REFERENCE TO RELATED APPLICATIONS

The present application claims priority to U.S. Provisional Application No. 62/573,606 filed on Oct. 17, 2017 titled, VENTILATED SUPPORT DEVICE, the complete disclosure of which is hereby incorporated by reference.

### BACKGROUND OF THE INVENTION

### 1. Field of Invention

The present invention relates to support devices and more specifically, ventilated support devices that passively force air circulation. 2. Description of Related Art

Cushion devices are used throughout everyday life as a means for making objects more comfortable. Cushions are often applied to areas that are hard or uncomfortable as a means to reduce stress and to soften impacts that would otherwise cause discomfort. This is typically accomplished by implementing various shock absorbing materials. Commonly, softer and/or thicker materials are used to further reduce the amount of stress a user may experience.

Such cushion devices are often applied against the human body. For example, the soles of a shoe are applied against the foot, seat cushions are applied against the buttocks, and pillows and headrests are applied against the head. Since the human body constantly radiates heat, this heat is absorbed into the cushioning material. In warmer climates, the trapped heat within the cushion creates a heat-sync that forces the user to choose between either removing the cushion and resting on a hard surface or utilizing the cushion along with its uncomfortable heat-sync properties.

Other cushion devices are often implemented to absorb shock. These cushion devices are designed to make wearing the shoe more comfortable through shock absorption. These cushion devices in the shoe sole, however, are commonly plagued by a lack of ventilation. The lack of air flow and ventilation through the cushion device can lead to increased levels of humidity that often lead to a fungal infection such as athlete's foot. At a minimum, the user is forced to endure warm, moist feet that can cause unpleasant odors.

Currently available in the art are shoes that have air channels. For example, United States Application Publication No. 2009/0044431 to Hypponen discloses a boot having a built-in air channel that runs along the sole of the shoe and terminates at the top of the boot's upper. However, Hypponen's design is flawed because the air channel is continuous, thereby lending itself to becoming clogged, and because it only draws and releases air in a single location—at the boot's upper.

Another attempt at solving the problems herein is U.S. Pat. No. 6,751,890 to Tsai, which discloses a ventilated shoe bottom. However, Tsai drawbacks include (1) that its ventilation holes are prone to blockage and (2) that the air is drawn from and returned to the interior of the shoe, thereby preventing fresh air from circulating within the shoe. Additionally, Tsai requires two special mating surfaces to manufactured and assembled to function properly.

Seat cushions are another common cushion device that often have heat-sync properties. In vehicles, seat cushions subject their users to uncomfortable conditions while being confined in a small space. One option is to use the vehicle's air conditioner to combat the heat. But not all vehicles have air conditioning and, even if it does, the air conditioning does little to cool a user's back. In an office setting, personnel often sit on chairs for extended periods of time. The cushion device in office chairs are typically constructed of wood, plastic, metal, leather, or a combination thereof. These materials do little to assuage the humidity and heat generated by the human body.

One attempt to solve this problem is U.S. Pat. No. 10,029,591 to Paez, which discloses a ventilated seat bad for a vehicle seat. However, the cushion disclosed in Paez requires an external system to force the air through a manifold. Such a system is not portable nor is one generally readily available—not all vehicle have air-conditioning. Additionally, Paez's manifolds are prone to blockage and can only have air forced therein at a single, predetermined location.

Backpacks are another item plagued by the heat generated by the user. Backpacks are especially vulnerable because the user is often engaged in some physical activity such as walking, running, hiking, climbing, or cycling. This above-normal physical activity exacerbates the problem because it causes the body to generate more heat and more sweat, thereby increasing the amount of heat and moisture absorbed into the cushioning surface.

Mattresses are another every-day item that forces a user to choose between alternative uncomfortable situations—feeling physical stress or being hot and sweaty. Mattresses typically comprise a top surface that is soft and pliable, made of a fabric upon which a user may rest or sleep. This pliable top surface traps the user's heat and moisture creating a notoriously uncomfortable environment. Bedridden patients often experience bedsores because a mattress' top surface, by trapping heat and moisture, creates the perfect breeding grounds for bacteria, fungi, and other ailments.

For at least the foregoing reasons, there is a need for a ventilated support device that does not trap the heat or moisture generated by its user, that does not require an external system for air circulation, and can be applied to multiple type of surfaces such as shoe soles, seat cushions, backpacks, and beds. This need has heretofore remained unsatisfied.

### SUMMARY OF THE INVENTION

The present disclosure provides a ventilated support device that alleviates the physical stress associated with resting against a hard surface while mitigating the uncomfortable heat and moisture for the user by utilizing passive air circulation. In an exemplary embodiment, the ventilated support device comprises a first layer, a second layer, and a plurality of support capsules disposed between the first layer and the second layer. The support capsules are configured such that they are deformable when an external force is applied to the first layer, thereby displacing the air around the deformed capsules. This displaced air may be channeled to other areas of the device, through vent holes in the first or second layers, and/or vent holes traversing the perimeter of the support device.

In an exemplary embodiment, a ventilated support device comprises a first layer having a first side and a second side, a plurality of flexible support capsules disposed on the second side of the first layer, a plurality of ventholes extending from the first side to the second side of the first layer, and a plurality of vias disposed among the plurality of support capsules. In some embodiments, the first layer is sufficiently flexible to deform under an externally-applied force and the plurality of support capsules comprises a plurality of flexible materials such that they force air movement through the plurality of vias.

In another exemplary embodiment, the ventilated support device further comprises a second layer disposed along the plurality of support capsules and oriented opposite the first layer.

In another embodiment, the ventilated support device's second layer further comprises a plurality of vent holes disposed therethrough.

In another embodiment, the ventilated support device's plurality of support capsules is spherically shaped.

In another embodiment, the ventilated support device's support capsules comprise an outer layer comprising a first flexible material encapsulating an inner layer comprising a second flexible material.

In another embodiment, the ventilated support device's second flexible material is selected from the group consisting of: air, a liquid, and a gel.

In another embodiment, the ventilated support device's plurality of support capsules are interconnected and attached to either the first layer or the second layer.

In another exemplary embodiment of the present disclosure, the ventilated support device may incorporated into a shoe. In such an embodiment, a shoe with an integrated ventilated support device comprises an upper and a sole; the ventilated support device is disposed between the upper and the sole. In such an embodiment, the ventilated support device may comprise a first layer, a second layer, a plurality of flexible support capsules disposed between the first layer and the second layer, and a plurality of vias interposed among the plurality of support capsules.

In another embodiment, the shoe with an integrated ventilated support device's first layer comprises a plurality of vent holes disposed therethrough.

In another embodiment, the shoe with an integrated ventilated support device further comprises a support wall traversing the perimeter of the ventilated support device.

In another exemplary embodiment of the present disclosure, a method for ventilation comprises applying a force to a first layer comprising a flexible material, wherein the force is transferred from the first layer to a plurality of flexible support capsules disposed between the first layer and a second layer; and deforming at least one of the plurality of flexible support capsules, thereby displacing air through a plurality of vias interspersed among the plurality of support capsules.

In another embodiment, the first layer comprises a plurality of vent holes disposed therethrough.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present disclosure, the objects and advantages thereof, reference is now made to the ensuing descriptions taken in connection with the accompanying drawings briefly described as follows:

FIG. 1A illustrates a side view of the ventilated support device, according to an exemplary embodiment of the present disclosure;

FIG. 1B illustrates an elevated isometric view of the ventilated support device, according to an exemplary embodiment of the present disclosure;

FIG. 1C illustrates an isometric exploded view of the ventilated support device, according to an exemplary embodiment of the present disclosure;

FIG. 2A illustrates a side view of the ventilated support device showing air flow, according to an exemplary embodiment of present disclosure;

FIG. 2B illustrates an isometric view of the ventilated support device showing air flow, according to an exemplary embodiment of the present disclosure;

FIG. 3A illustrates an isometric view of a ventilated support device as applied to a shoe insert or sole, according to an exemplary embodiment of the present disclosure;

FIG. 3B illustrates an isometric cut-away view of a ventilated support device as applied to a shoe, according to an exemplary embodiment of the present disclosure;

FIG. 4A illustrates an exploded view of a ventilated support device having uniquely-shaped support capsules, according to an exemplary embodiment of the present disclosure;

FIG. 4B illustrates an exploded view of a ventilated support device having cylindrically-shaped support capsules, according to an exemplary embodiment of the present disclosure;

FIG. 5 illustrates a ventilated support device applied to a backpack, according to an exemplary embodiment of the present disclosure;

FIG. 6 illustrates a ventilated support device applied to a chair, according to an exemplary embodiment of the present disclosure; and

FIG. 7 illustrates a ventilated support device applied to a bed, according to an exemplary embodiment of the present disclosure.

### DETAILED DESCRIPTION OF EMBODIMENTS

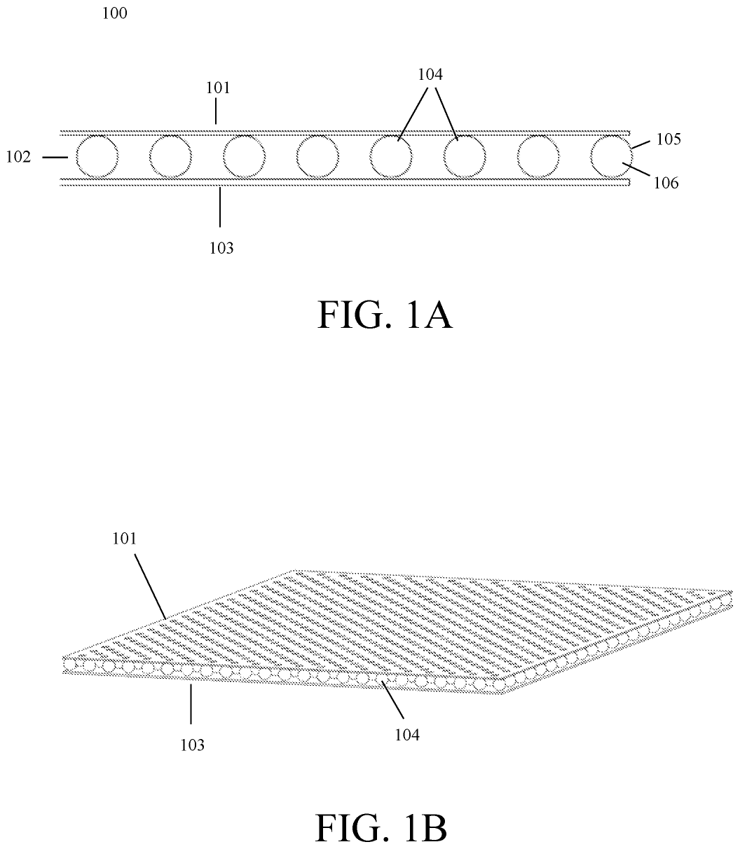

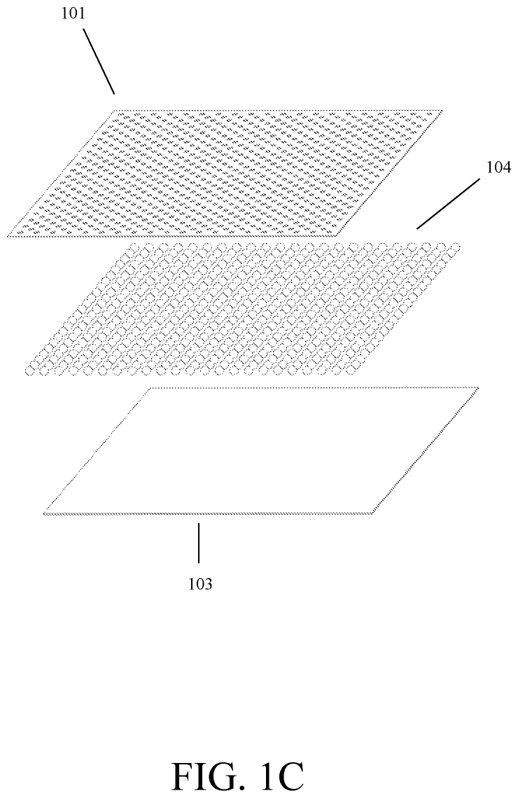

Further features and advantages of the disclosure, as well as the structure and operation of various embodiments of the disclosure, are described in detail below with reference to the accompanying FIGS. 1-7.

In an exemplary embodiment of the present disclosure, the ventilated support device comprises a first layer and a plurality of support capsules. The first layer may be made from any flexible or semi-rigid material. The first layer may have a plurality of vent holes disposed therethrough. The vent holes allow are to move from one side of the first layer to the other while allowing the first layer to flex and/or deform. The plurality of support capsules may be made from any semi-rigid or flexible material.

The support capsules may be made of a single solid material. Alternatively, the support capsules may comprise a flexible outer layer encapsulating another material. For example, the capsule's outer layer may be made from a first flexible material surrounding a second flexible material. Alternatively, the capsules may comprise a fluid surrounded by an outer lay. The capsule's inner fluid may comprise air, or other gaseous fluids or liquids.

A plurality of vias may be disposed around the plurality of support capsules. The vias allow air to pass in and around the support capsules. The plurality of support capsules may be interconnected such that the individual support capsules of the plurality of support capsules are held in their respective position. For example, an individual support capsule may be connected to the surrounding capsules. Alternatively, the plurality of support capsules may be connected to the first layer.

In some embodiments, the ventilated support device comprises a first layer and a plurality of support capsules. In another embodiment, the ventilated support device comprises a plurality of support capsules disposed between a first layer and a second layer. The first layer or the second layer may have ventholes disposed therethrough. Additionally, the first layer may be made from the same material as the second layer. Alternatively, the first layer may be made from a material or combination of materials that are different from the material or combination of materials used to make the second layer.

FIG. 1A illustrates a side view of a ventilated support device consistent with the present invention. The ventilated support device 100 may comprise a middle layer 102 disposed between a first layer 101 and a second layer 103. The first layer 101 may comprise a semi-rigid material. The middle layer 103 comprises a plurality of support capsules 104. The plurality of capsules 104 may comprise an outer layer 105 disposed around the capsule's interior 106. The interior 106 may comprise a fluid, such as air, or other gaseous mixture. The interior 106 may also comprise a liquid fluid such as water. The interior 106 may also comprise a polymeric or elastomeric material that allows the interior to deform and readily return to its pre-deformed shape. The capsule's outer layer 105 may comprise a flexible and/or deformable material such that the capsule 104 may readily return to its pre-deformed shape. For example, the capsule's outer layer 105 may comprise an elastomeric, polymeric, or other polymer-based compound that is flexible enough to allow the capsule to deform under an external force or pressure, yet sufficiently flexible to return to its pre-deformed shape once the external force has been removed. The bottom layer 103 may comprise a semi-rigid material. Although the capsules 104 are shown as being substantially round, the capsules 104 may comprise any shape.

FIG. 1B illustrates an elevated isometric view of the ventilated support device according to an exemplary embodiment of the present disclosure. The first layer 101 may comprise a plurality of vent holes. The second layer 103 may also comprise a plurality of vent holes (not shown). Although the vent holes disposed on the first layer 101 are shown as circular, the vent holes may have any shape.

FIG. 1C illustrates an exploded isometric view of the ventilated support device, according to an exemplary embodiment of the present disclosure. As shown, the first layer 101 comprises a plurality of vent holes dispersed therethrough. The plurality of capsules 104 are disposed between the first layer 101 and the second layer 103.

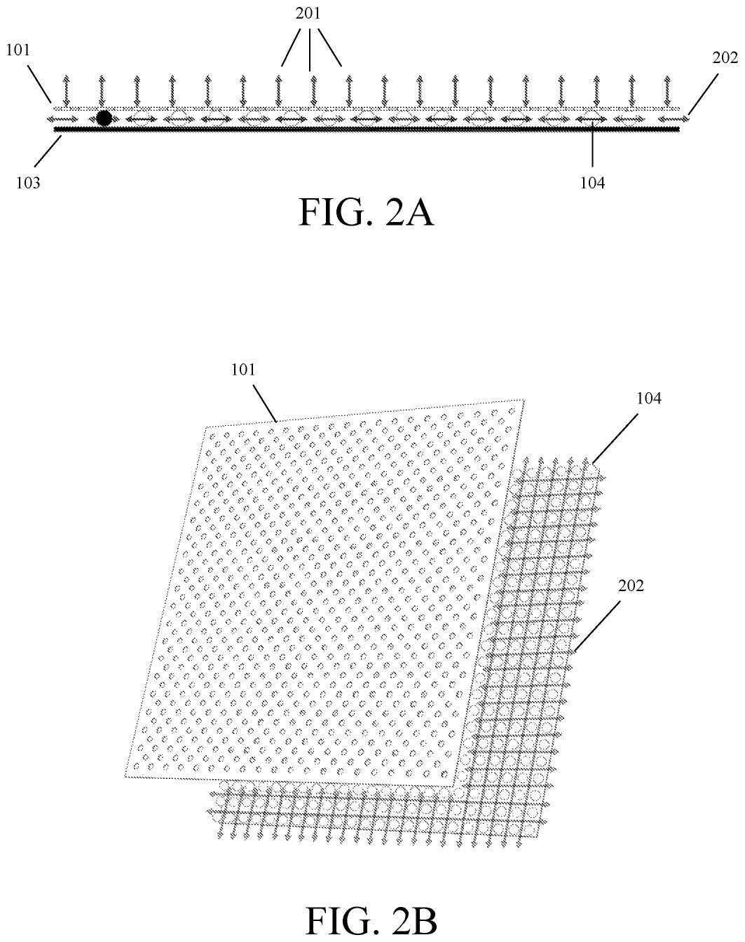

FIG. 2A illustrates a side view of the ventilated support device showing air flow patterns, according to an exemplary embodiment of the present disclosure. When an external pressure is applied to the first layer 101 of the ventilated support device, the first layer 101 transfers that pressure to a plurality of the capsules 104, causing them to compress and deform. When the capsules 104 deform, the air between the capsules 104 is forced laterally and vertically. The lateral air movement 102 causes air to move to other areas between the first layer 101 and the second layer 103 that are not as compressed. Additionally, the vertical air movement 201 causes the air to pass through the vent holes traversing the first layer 101. Through the application of the external force, ventilated support device accomplishes (1) providing support by distributing the applied force across a greater area, (2) compressing the capsules 104 which in turn provide resistive force to the applied pressure, in some proportionality to the applied external force, and (3) causing the deformed capsules 104 to passively force air around the capsules 104 and through the vent holes, thereby indirectly providing forced ventilation.

FIG. 2B illustrates an isometric exploded view of the top layer 101 and the plurality of the support capsules 104, according to an exemplary embodiment of the present invention. When the support capsules 104 are deformed due to an external force, the capsules 104 will force air in lateral and longitudinal directions along a plurality of vias (shown as arrows 202).

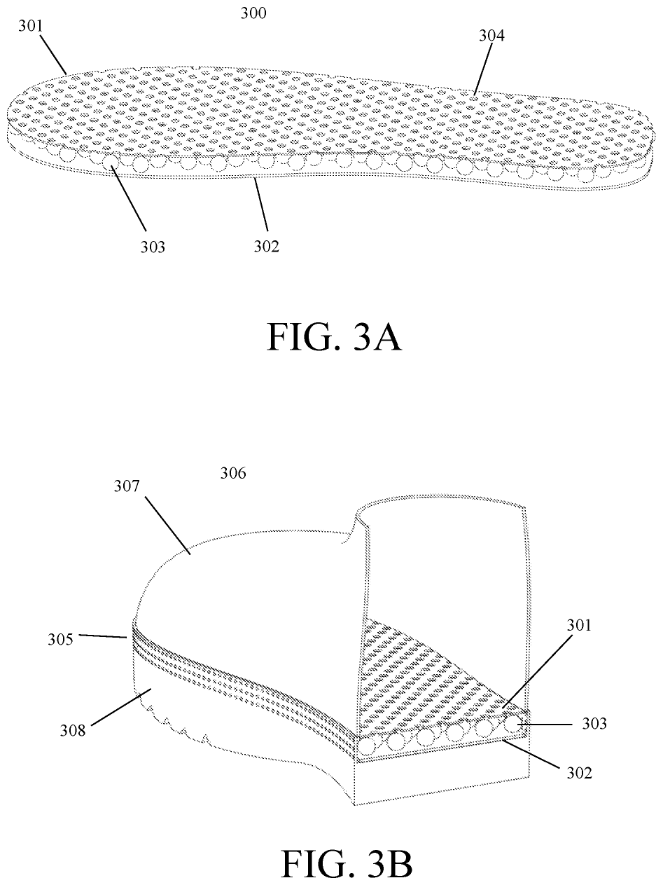

In another exemplary embodiment of the present disclosure, and with reference to FIG. 3A, the ventilated support device 300 is configured in the form of a shoe insert. The ventilated support device 300 may comprise a first layer 301 and a second layer 302. The first layer 301 may comprise a plurality of ventilation orifices 304, through which air may pass. A plurality of support capsules 303 are disposed between the first layer 301 and the second layer 302.

In another exemplary embodiment of the present disclosure, and with reference to FIG. 3B, the ventilated support device 300 may be incorporated into a shoe 306. The shoe 306 comprises an upper 307 and a sole 308. The ventilated support device may be integrated into the sole 308. Alternatively, the ventilated support device may be disposed between the upper 307 and the sole 308. The ventilated support device 300 may have also comprise a wall 305 that traverses the edge of the support device 300. In such an embodiment, the wall 305 may have ventilation orifices that allow air to circulate from the exterior of the shoe 306 to the interior. In such a configuration, when the user steps on the shoe, the plurality of support capsules 303 will deform and compress under the user's weight. As the user repetitively applies and releases pressure, for example by walking or running, the plurality of support capsules 303 will deform and force air circulation, around the through the vent holes 304 and/or wall 305. The wall 305 may also provide structural support to the first layer 301 and/or the second layer 302.

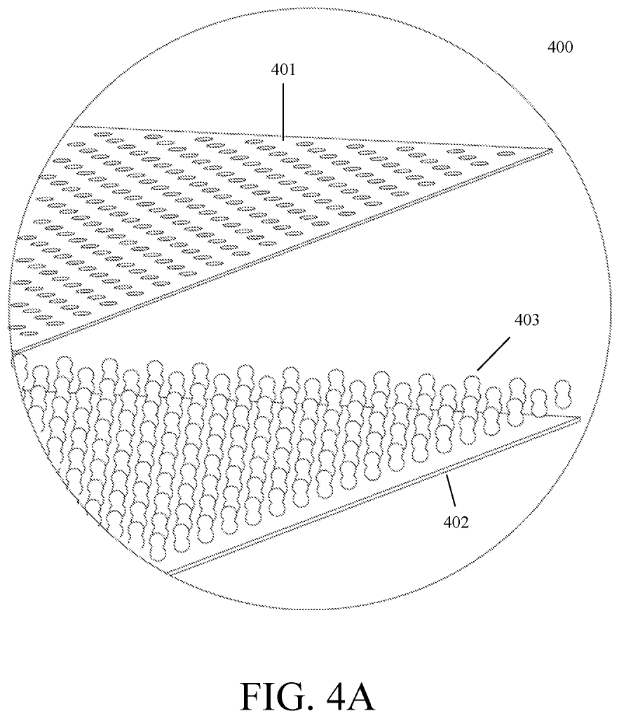

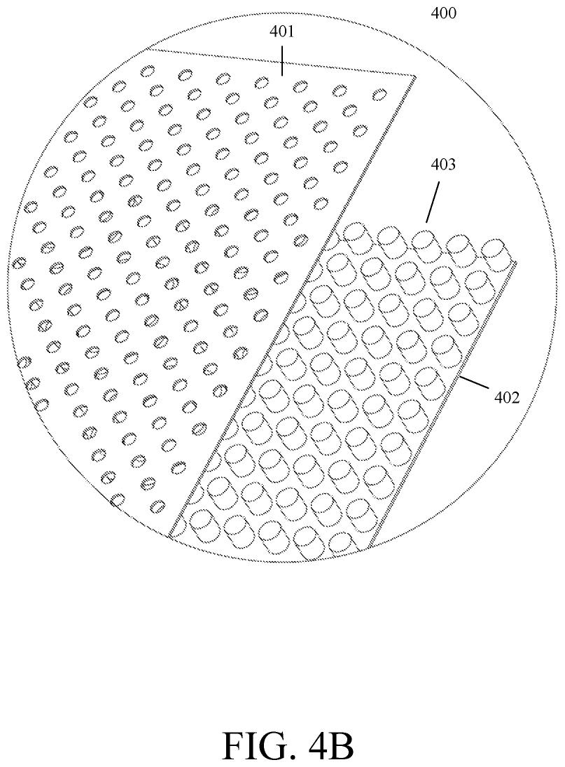

In another exemplary embodiment of the present disclosure and with reference to FIG. 4A, the ventilated support device 400 comprises a first layer 401, a second layer 402, and a plurality of support capsules 403. Notably, the plurality support capsules 403 can be any shape. For example, the support capsules 403 can be “dog bone” shaped. Further, although the plurality of support capsules are shown as uniformly shaped and sized, the individual support capsules 403 making up the plurality of support capsules 403 may be of any size and shape.

In another exemplary embodiment of the present disclosure and with reference to FIG. 4B, the ventilated support device 400 comprises a first layer 401, a second layer 402, and a plurality of support capsules 403. As shown, the support capsules 403 may be of any shape or size, including being cylindrical. Notably, the plurality of support capsules 403 may be of varying shapes and sizes.

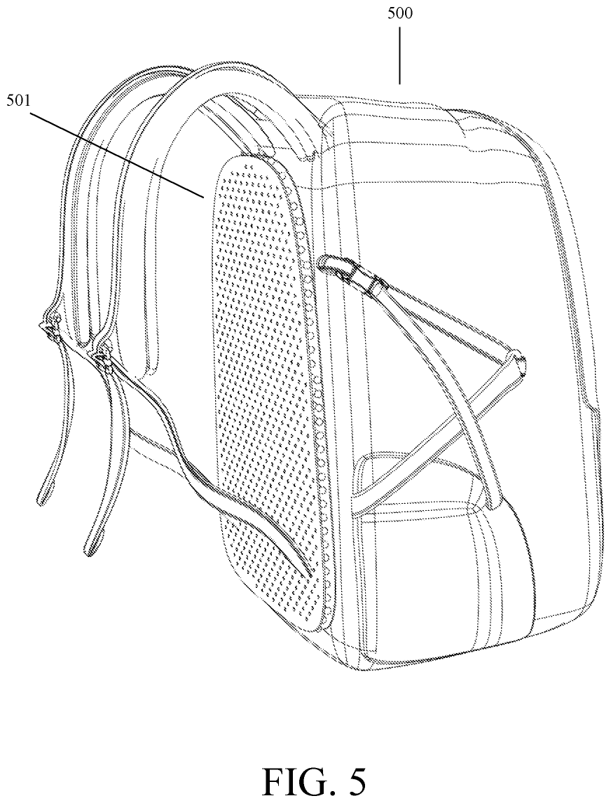

In another exemplary embodiment of the present disclosure, and with reference to FIG. 5, the ventilated support device 501 may integrated into everyday items. For example, the ventilated support device 501 may be integrated into a backpack 500 such that the support device 501 provides comfort to the wearer of the backpack 500. Additionally, the ventilated support device can also be integrated into the backpack's 501 straps (not shown).

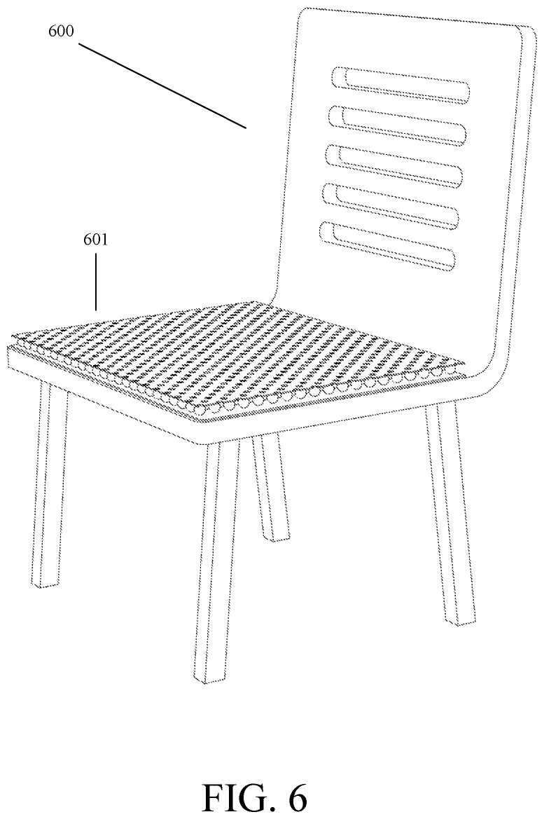

In another exemplary embodiment of the present disclosure and with reference to FIG. 6, the ventilated support device 601 may be incorporated into the seat portion of a chair 600.

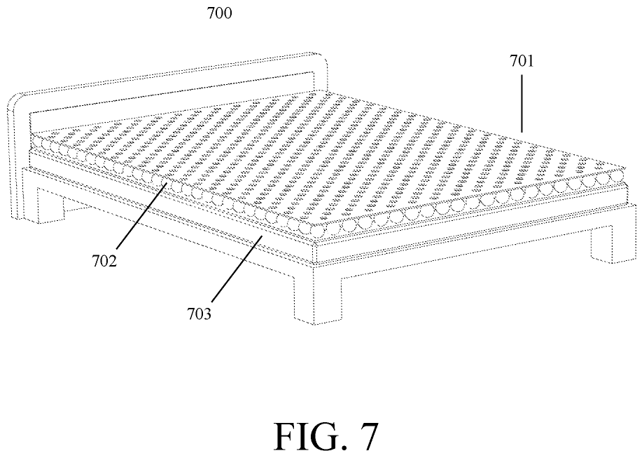

In another exemplary embodiment of the present disclosure and with reference to FIG. 7, the ventilated support device 701 can be integrated into a bed 700. Notably, the plurality support capsules 702 may be much larger than those integrated into a show, e.g., FIG. 3, a backpack, e.g., FIG. 5, or a seat, e.g., FIG. 4. Additionally, the ventilated support device 701 may be placed over an existing mattress 703. Alternatively, the ventilated support device 701 may be integrated into a bed's mattress 703.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A ventilated support device comprising:
a first layer having a first side and a second side;
a plurality of flexible support capsules disposed on the second side of the first layer;
a plurality of ventholes extending from the first side to the second side of the first layer; and
a plurality of vias disposed among the plurality of support capsules;
wherein the first layer is sufficiently flexible to deform under an externally-applied force; wherein the plurality of support capsules comprises a plurality of flexible materials such that they force air movement through the plurality of vias.

2. The ventilated support device of claim 1 further comprising a second layer disposed along the plurality of support capsules and oriented opposite the first layer.

3. The ventilated support device of claim 2, wherein the second layer further comprises a plurality of vent holes disposed therethrough.

4. The ventilated support device of claim 1, wherein the plurality of support capsules is spherically shaped.

5. The ventilated support device of claim 1, wherein the support capsules comprise an outer layer comprising a first flexible material encapsulating an inner layer comprising a second flexible material.

6. The ventilated support device of claim 5, wherein the second flexible material is selected from the group consisting of: air, a liquid, and a gel.

7. The ventilated support device of claim 2, wherein the plurality of support capsules are interconnected and attached to either the first layer or the second layer.

8. A shoe with an integrated ventilated support device, comprising:
an upper; and
a sole;
wherein the ventilated support device is disposed between the upper and the sole; and
wherein the ventilated support device comprises:
a first layer;
a second layer;
a plurality of flexible support capsules disposed between the first layer and the second layer; and
a plurality of vias interposed among the plurality of support capsules.

9. The shoe with an integrated ventilated support device of claim 8, wherein the first layer comprises a plurality of vent holes disposed therethrough.

10. The shoe with an integrated ventilated support device of claim 8, wherein a support wall traverses the perimeter of the ventilated support device.

11. A method for ventilation comprising:
applying a force to a first layer comprising a flexible material, wherein the force is transferred from the first layer to a plurality of flexible support capsules disposed between the first layer and a second layer; and
deforming at least one of the plurality of flexible support capsules, thereby displacing air through a plurality of vias interspersed among the plurality of support capsules.

12. The method for ventilation of claim 11, wherein the first layer comprises a plurality of vent holes disposed therethrough.

13. The method of claim 11, wherein the support capsules comprise an outer layer comprised of a first material disposed around an inner layer comprised of a second material.
